(19) United States
(12) Patent Application Publication
(10) Pub. No.: US 2010/0193054 A1
(43) Pub. Date: Aug. 5, 2010

(54) PORTABLE COMPRESSOR

(75) Inventors: Hector Ray Hernandez, Fullerton, CA (US); Vince Caito, Pomona, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: ALLTRADE TOOLS LLC, Long Beach, CA (US)

(21) Appl. No.: 12/365,046

(22) Filed: Feb. 3, 2009

(51) Int. Cl. B67D 5/00

(52) U.S. Cl. 137/565.18

(57) ABSTRACT

A portable air compressor including a base platform, a motor, a compressor, a first and a second cylindrical air tank. A vertically extending rod is attached to the base platform. At least two feet are connected to the second tank, for supporting the second tank on the first tank. A cylindrical collar is attached to an external surface of the second tank, the collar being positioned to slide over an upper portion of the rod when the second tank rests on the first tank, and holds the second tank immovable on the compressor, yet allows the second tank to be removed from the compressor when desired.

### BACKGROUND

The present application relates to portable air compressors.

Air compressors are well known. Many tools are configured to run on compressed air, which eliminates many of the risks associated with running on electric motors incorporated into the tool itself. For example, where water may be present, electrical short circuits are an ever present danger to the safety of the user of such a tool. Thus, an air compressor in one form or another may be found in most workshops and garages today as an indispensable component of an artisan's equipment. Air compressors have developed from large unwieldy devices that are typically installed on wheels for mobility, on the one hand, to smaller portable systems, on the other hand, that an artisan may carry about by a handle, deposit in a vehicle, carry up floors of a structure, and generally use as an extension of a portable tool that runs on compressed air.

As an extension to the portability of air compressors, some manufacturers have included, as a component of a portable compressor, a tank for storing compressed air that is separable and removable from the main body of the compressor, where the main body includes the electric motor and compressor for compressing the air for storage. This aspect allows the artisan to use the removable tank alone for supplying a limited amount of compressed air if it should be needed at a location remote from where the compressor is located. For example, if an artisan knows that he may have to let some air out of the tires of his vehicle to negotiate a sand track, then he may fill a removable tank with compressed air and take only the tank along with him so that he can inflate his tires once the sand track has been negotiated and his vehicle is back on firmer terrain. This aspect has utility because the artisan need not carry with him the entire compressor with all its heavier components, but may simply select the tank to take with him, and this selection is feasible so long as he does not require the use of a large amount of compressed air at the remote location.

A problem encountered in the art is that separable or removable storage tanks for air compressors are typically cylindrical in profile. As such, they are frequently unstable when placed on the ground because they may tend to roll. Furthermore, systems for connecting a removable storage tank to the compressor tend to add excessive weight to the compressor, which is disadvantageous for portable compressors.

Thus, there is a need in the art for a portable air compressor having a removable tank that will be easy to attach to the compressor, will be easy to remove, will add little weight to the compressor, and which will enable the tank to remain stable when placed on the ground. The present invention addresses these and other needs.

### SUMMARY OF THE INVENTION

According to a preferred embodiment of the invention, there is described a portable air compressor having features of the present invention. In a preferred embodiment, the compressor comprises a base platform, a motor attached to the base platform, a compressor attached to the base platform and a first cylindrical air tank attached to the base platform, the first tank having an outer diameter with a first radial curvature. A vertically extending rod is attached to the base platform. A second cylindrical air tank is provided, configured to be positioned above, adjacent to, and parallel with the first air tank. A flexible hose connects the first tank to the second tank, wherein the hose is disconnectable from the second tank.

At least two feet are connected to the second tank, each foot including an arcuate portion having a second radial curvature substantially the same as the first curvature, each foot being configured such that, when the second tank is positioned above, adjacent to, and parallel with the first tank, each foot rests on the first tank and the arcuate portion is in contact with the first tank over the length of the arcuate portion. In this manner, an advantageous feature is provided in that the load from the feet is evenly distributed as the second tank is supported on the first tank, and the feet are protected from puncturing the first tank.

A cylindrical collar is attached to an external surface of the second tank, the collar being positioned to slide over an upper portion of the rod when the second tank rests on the first tank. A threaded set screw is inserted through a threaded hole in the collar, whereby tightening the set screw frictionally engages the screw with the rod and locks the second air tank immovable in relation to the compressor, and loosening the set screw disengages the screw from the rod and unlocks the second air tank to render it removable from the compressor. This lightweight locking feature provides flexibility and facility in attaching and removing the second tank from the compressor when desired.

In another aspect of the invention, the compressor includes a handle for lifting the compressor, the handle being positioned substantially above the center of gravity of the compressor. Preferably, the handle is connected to the compressor through a post that is directly connected to the base platform, and an elongate axis of the handle extends horizontally when the compressor is resting on a horizontal surface. These features advantageously allow the compressor to be lifted by the handle without the compressor tilting sideways under the action of gravity.

In yet a further aspect of the invention, the length of the arcuate portion of each foot is preferably between four and seven inches and the feet are spaced apart between nine and twenty inches. Further preferably, each arcuate portion terminates in a lowest point at either end of the arcuate portion, and each point lies in a single plane, thereby permitting the first tank to be placed on a planar surface without a wobble being set up.

The above and other features of the present invention will be explained in greater detail by reference to the attached figures and the detailed description of the preferred embodiment which follows. As set forth herein, the present invention resides in the novel features of form, construction, mode of operation and combination of processes presently described and understood by the claims.

### BRIEF DESCRIPTION OF THE DRAWINGS

FIG. 1 shows a perspective view of an air compressor having features of the present invention.

FIG. 2 is a perspective view of the air compressor of FIG. 1, showing an air tank removed from the compressor.

FIG. 3 is a left side view of the air compressor of FIG. 1.

FIG. 4 is a right side view of the compressor of FIG. 1, showing an air tank removed from the compressor, as in FIG. 2.

FIG. 5 is a detailed perspective view of an aspect of the air compressor of FIG. 1.

FIG. 6 is a perspective view of a portion of the air compressor of FIG. 1.

FIG. 7 is a perspective view of a portion of the air compressor of FIG. 1.

### DETAILED DESCRIPTION OF THE PREFERRED EMBODIMENTS

With reference to the Figures there is shown, by way of exemplification and not limitation, an air compressor having features of the present invention, generally identified by the numeral 20. Preferably, components of the air compressor are positioned on a base 22 that includes a plurality of feet 23 for stabilizing the compressor when it is placed on the ground or other support surface. The feet may be adjustable in length by threadable attachment, so that the compressor does not wobble when resting on a planar surface.

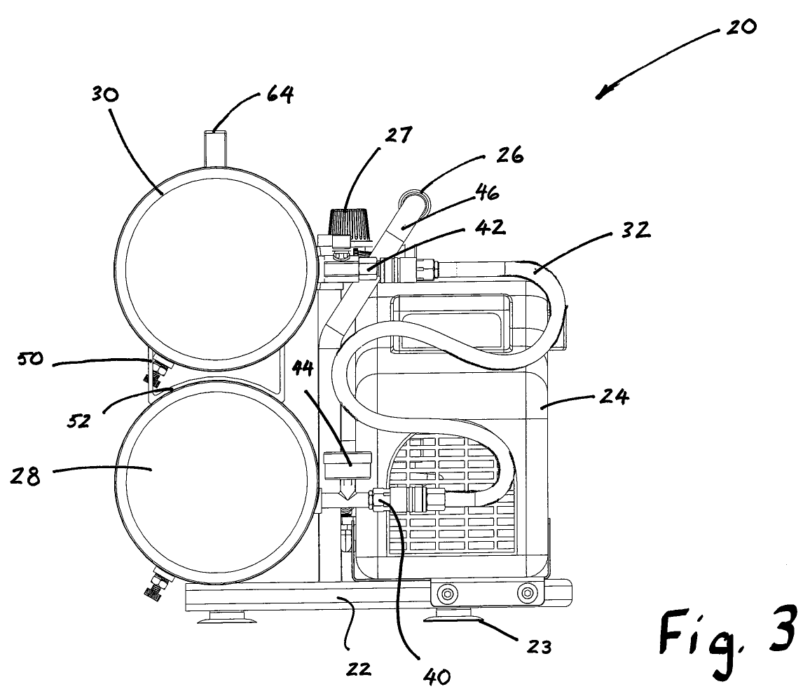

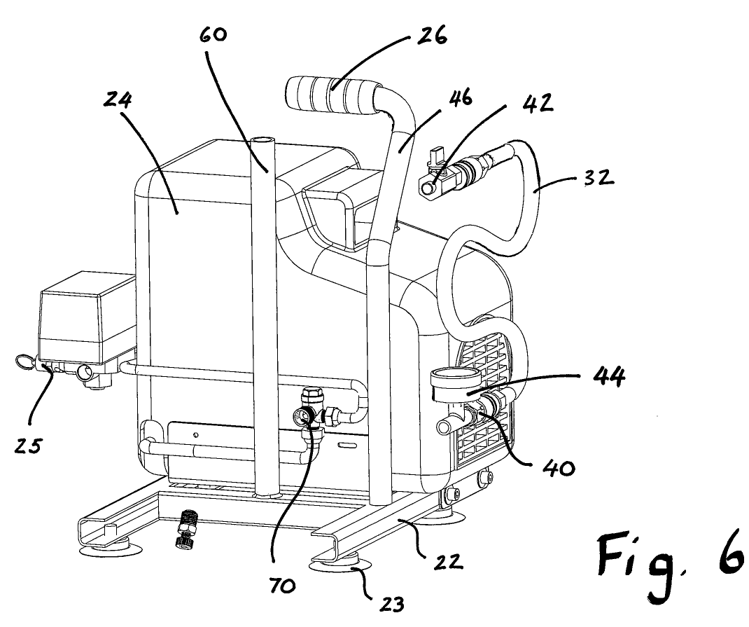

Components of the air compressor include an electric motor (not visible) enclosed within a housing 24. The motor drives an air compressor pump (not visible) that may also be enclosed within the housing 24. The air compressor draws in air at atmospheric pressure, and by pump action compresses the air to around 120 p.s.i. before passing the air through a one way pressure valve 70 (FIG. 6) into a first cylindrical air pressure tank 28. The first air pressure tank 28 is connected to a second air pressure tank 30 via a pressure hose 32 (best seen FIG. 3). However, the second air tank 30 may be electively isolated from the first tank 28 by one or both of two valves on the hose 32 that may be open or closed by a user. A first cut-off valve 40 is positioned on the hose 32 adjacent the first tank 28, and a second cut-off valve 42 is positioned on the hose adjacent the second tank 30.

Between the first tank 28 and the first cut-off valve 40, a pressure gauge 44 (FIG. 3) may be installed so that the pressure in both tanks may be measured when the tanks are connected by the hose 32, or pressure in the first tank may be measured when either one of the cut-off valves 40, 42 is closed. A pressure relief valve 25 is operatively connected, via a conduit, to the pressure valve 70, to allow air to bleed off in the event of over pressurization.

Thus, the first tank 28 and second tank 30 may be filled with compressed air simultaneously. With both cut-off valves 40, 42 open, the compressor is driven by the electric motor, and compressed air is pumped into both tanks under equal pressure. Of course, the pumped air enters the first tank 28 first, via pressure valve 70 (FIG. 6), and then enters the second tank 30 to equalize the pressure in each tank. A user may then turn off the motor and the compressor pump. The compressed air will not escape back into the pump because of the one way valve 70 positioned between the pump and the tanks. The second tank 30 includes an outlet 29 via a regulator 27, that allows a user to extract the compressed air in the tanks under control of the regulator to provide a desired exit pressure. A female quick-lock type connector is provided at the outlet 29 of the second tank for the user to attach a suitable hose (not shown) to which a desired tool may be connected. Typically, a suitable hose may be configured to naturally assume the shape of a helical coil, so that after it has been used it will recoil to its natural shape to minimize the space it occupies.

In use of the air compressor, the artisan may utilize the compressed air in the tanks to run an air driven tool such as a sprayer, drill, or hammer, or other tool (all not shown). However, in utilizing the compressor, the artisan may find it necessary to move the compressor about, to suit the length of the coiled hose and the position of the work being done in relation to the compressor. To facilitate such movement, a handle 26 is provided. Preferably, the handle is oriented with its longitudinal axis horizontal when the compressor is placed on a horizontal surface, and is covered with a polymerized or rubberized grip. The horizontal handle 26 is connected to the base 22 of the compressor via a vertically extending post 46. The horizontal handle 26 is positioned over the center of gravity of the compressor 20, so that the compressor may be lifted by the handle without it tilting sideways under the action of gravity.

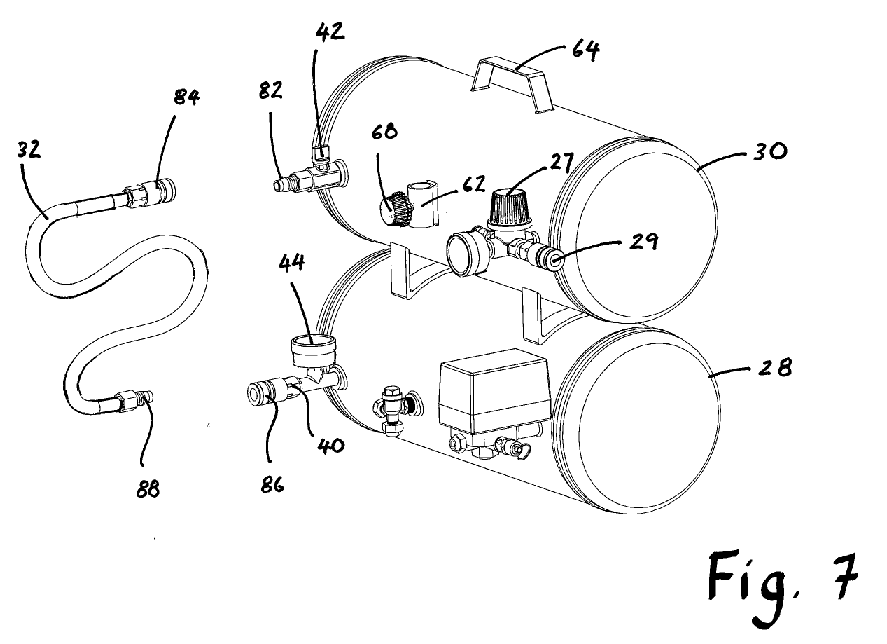

Under certain circumstances, the artisan may require to use a limited amount of compressed air in a location that is difficult to reach, or where it is inconvenient to locate the compressor. For example, the artisan may have to perform an application requiring a limited amount of compressed air at the top of a ladder where it would be difficult to elevate the whole compressor. Alternatively, he may require to have a limited amount of compressed air to inflate the tires of a vehicle after driving it on uneven terrain, where it would be inconvenient to transport the entire compressor. In these circumstances, the compressor allows that the second tank 30, filled with compressed air, may be detached and removed from the compressor, and the compressed air within the second tank 30 may be used before the tank is returned and connected with the compressor. When such detachment and removal of the second tank 30 is effected, the second cut off valve 42 is closed, thereby isolating the compressed air in the second tank 30 from the compressed air in the first tank 28. To facilitate easy removal of the second tank, the cut off valve 42 may be combined with a male quick-lock type connector 82 (FIG. 7), configured to mate with a female quick-lock type connector 84 on the second end of the hose, which will allow the hose 32 to be rapidly disconnected from the second tank 30 without the tank losing pressure. Likewise, the first cut off valve 40 on the first tank 28 may be combined with a female quick-lock type connector 86 (FIG. 7), configured to mate with a male quick-lock type connector 88 on the first end of the hose, which will allow the hose to be rapidly disconnected from the first tank without losing pressure. Once the hose 32 is disconnected, the second tank 30 is free to be removed for use. Moreover, because of the fact that the hose 32 is disconnectable from the tanks at both ends, it may, in cases of emergency, be connected via its male connector 88, at the first end of the hose, to the female connector outlet 29 of the second tank to permit a tool to be connected directly to the second end of the hose 32. Alternatively, the hose 32 may be used as an extension to the coiled hose where necessary.

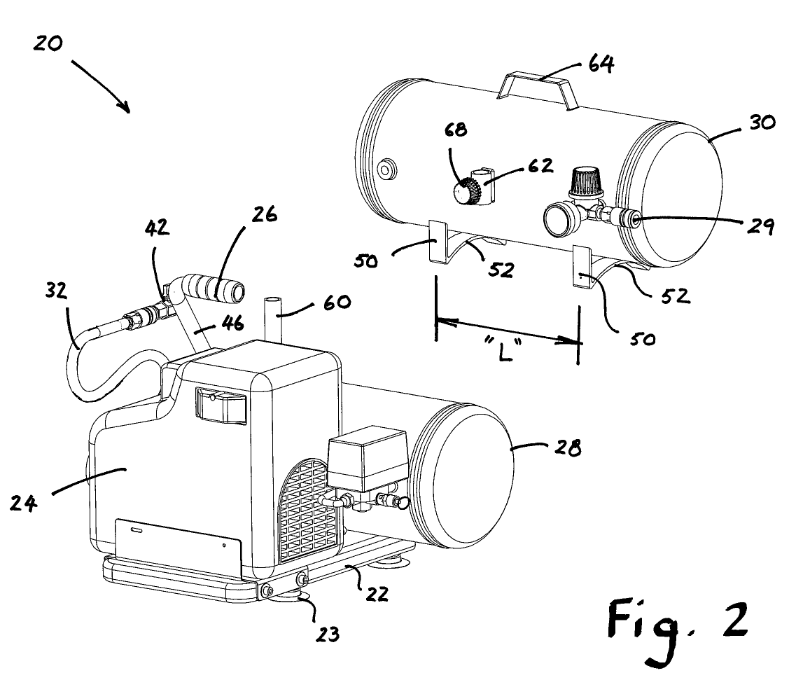

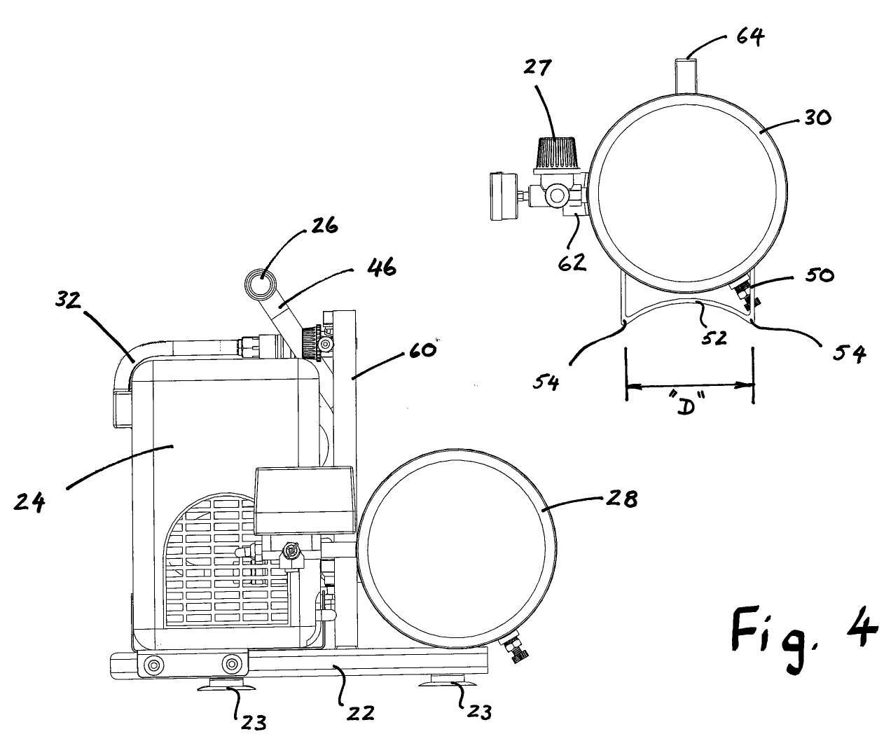

To facilitate these features of the compressor 20, the compressor is equipped with novel and useful features that enable the temporary detachment, removal, and use of the second tank 30 from the compressor 20 before the second tank is reinstalled on the compressor after use. To the under surface of the second tank 30, at least two supporting feet 50 are attached. The feet are specially shaped to accomplish a number of objectives. First, the feet are shaped to rest with stability on the first tank 28, and thereby to provide a secure platform for the second tank 30 to rest on the compressor, and in particular, to rest on the first tank 28. Specifically, the feet are shaped to prevent lateral movement of the second air tank 30 perpendicular to the longitudinal axis of the first air tank 28. The feet are also shaped to evenly distribute the load of the second tank 30 onto the first tank 28, so that the feet will not tend to puncture the first tank 28. To achieve these objectives, each foot includes an arcuate portion 52 having substantially the same radius of curvature as the outer diameter of the first cylindrical air tank 28. As best seen in FIG. 3, the arcuate portion 52 of each foot allows the second tank 30 to rest evenly on the first tank 28, and, when the first tank is restrained from upward movement, the arcuate portion 52 also restrains the second tank against lateral movement across the longitudinal axis of the first tank. Second, the feet are shaped to allow the second tank to rest with stability on the ground or any other planar support surface. To achieve this objective, each arcuate portion 52 terminates in a point 54 at either end of the arcuate portion (FIG. 4). Each of the four points 54 lies in a single plane to provide stability for the second tank 30 when the tank is placed on a planar horizontal surface. Preferably, the length of the arcuate portion (“D” in FIG. 4), measured in the direction of the arc, is between four and seven inches, and the spacing between the feet (“L” in FIG. 2) is preferably between 9 and 20 inches.

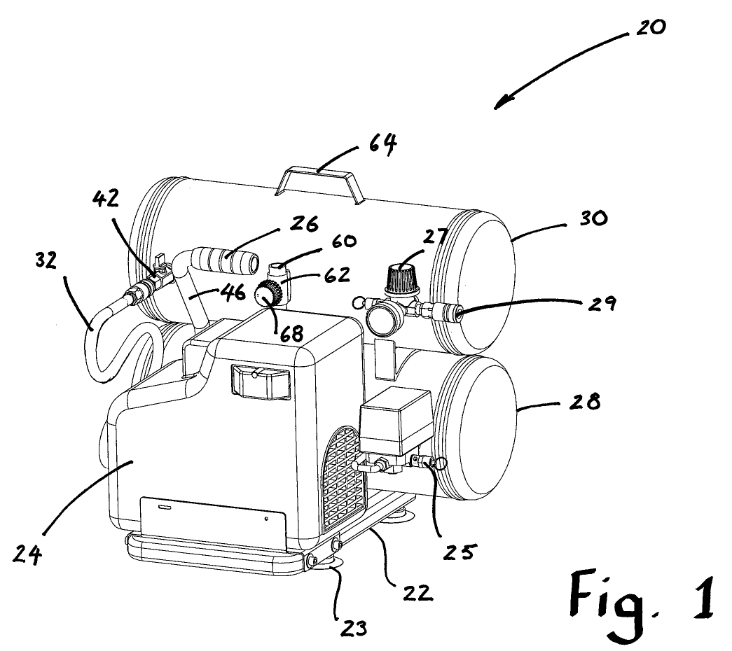

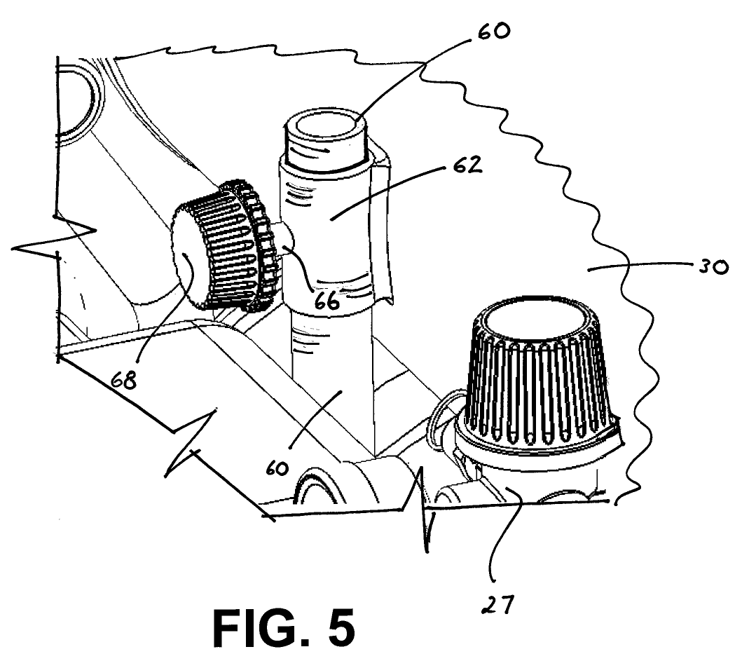

Moreover, the compressor 20 is provided with a lightweight locking structure for securing the second tank 30 to the compressor when the second tank is placed on the first tank 28 as exemplified in FIGS. 1 and 3, so that the second tank remains connected to the compressor during movement of the compressor, and can neither slide nor fall off the compressor while the compressor is being moved. The locking structure includes a fixed vertical rod 60 extending upwardly from the base 22 of the compressor. A cylindrical collar 62 is connected to the second tank 30, preferably half way between a handle 64 on the upper surface, and the feet 50 on the lower surface of the second tank. The collar is preferably circular in cross section, and the rod is preferably circular in cross section. The collar 62 is configured and positioned in relation to the second tank so that, when the second tank 30 is positioned to rest on the first tank 28, the collar slips over the upper portion of the vertical rod 60. This alone prevents the second tank from sliding along, or across, the longitudinal axis of the first tank. In order to provide even greater restraint against movement of the second tank in relation to the compressor, a set screw 66 is provided, threadably inserted into the collar 62 so that turning the set screw by a knob 68 (best seen FIG. 5) attached thereto will engage the set screw with the upper portion of the vertical rod 60, and will frictionally lock the collar 62 to the rod 60. Once the collar is locked to the rod, the second tank 30 is also secured against vertical movement in relation to the first tank. Thus, the second tank is secured against inadvertent bumps, or inversions of the compressor, which might allow the second tank to slide or fall off its position of support on the first tank 28. Conversely, by loosening the set screw, a user may temporarily remove the second tank 30 from the compressor for use in a location remote from the compressor as described above, before returning the second tank 30 to its position on the compressor and locking it back in position via set screw 66.

Thus, there has been described a novel and useful feature for air compressors having a cylindrical air tank, facilitating the temporary removal of an air tank from the compressor, and providing a support combined with locking structure for securing the removable air tank to the compressor during movement.

It will be apparent from the foregoing that, while particular forms of the invention have been illustrated and described, various modifications can be made without parting from the scope of the invention which is set forth in the claims.

We claim:

1. A portable air compressor comprising:
a base platform;
a motor attached to the base platform;
a compressor attached to the base platform;
a first cylindrical air tank attached to the base platform, the first tank having an outer diameter with a first radial curvature,
a vertically extending rod attached to the base platform;
a second cylindrical air tank configured to be positioned above, adjacent to, and parallel with the first air tank, the second air tank including:
a flexible hose connecting the first tank to the second tank, wherein the hose is disconnectable from the second tank;
at least two feet connected to the second tank, each foot including an arcuate portion having a second radial curvature substantially the same as the first curvature, each foot being configured such that, when the second tank is positioned above, adjacent to, and parallel with the first tank, each foot rests on the first tank and the arcuate portion is in contact with the first tank over the length of the arcuate portion;
a cylindrical collar attached to an external surface of the second tank, the collar being positioned to slide over an upper portion of the rod when the second tank rests on the first tank; and
a threaded set screw inserted through a threaded hole in the collar, whereby tightening the set screw frictionally engages the screw with the rod and locks the second air tank immovable in relation to the compressor, and loosening the set screw disengages the screw from the rod and unlocks the second air tank to render it removable from the compressor.

2. The air compressor of claim 1, wherein the cylindrical collar is circular in cross section.

3. The air compressor of claim 1, further including a handle connected to the compressor for lifting the compressor, the handle being positioned substantially above the center of gravity of the compressor.

4. The air compressor of claim 1, wherein the handle is connected to the compressor through a post that is directly connected to the base platform.

5. The air compressor of claim 4, wherein an elongate axis of the handle extends horizontally when the compressor is resting on a horizontal surface.

6. The air compressor of claim 1, wherein the length of the arcuate portion is between four and seven inches.

7. The compressor of claim 1, wherein the feet are spaced apart between nine and twenty inches.

8. The compressor of claim 1, wherein each arcuate portion terminates in a point at either end of the arcuate portion, and each point lies in a single plane.

9. The compressor of claim 1, wherein a first end of the hose has a male quick-lock type connector for connection to a first female quick-lock type connector on the first tank, and a second end of the hose has a second female quick-lock type connector for connection to a male quick-lock type connector on the second tank, whereby the hose is disconnectable from both the first tank and the second tank, and further wherein the second tank has a third female quick-lock type connector adapted to connect with the male quick-lock type connector at the first end of the hose, the third quick-lock type connector being separated from the second tank by a regulator, for regulating the discharge of air from the second tank.

10. A portable air compressor comprising:
a base platform;
a motor attached to the base platform;
a compressor attached to the base platform;
a first cylindrical air tank attached to the base platform;
a vertically extending rod attached to the base platform;
a second cylindrical air tank configured to be positioned above, adjacent to, and parallel with the first air tank, the second air tank including:
a flexible hose connecting the first tank to the second tank, wherein the hose is disconnectable from the second tank;
at least two feet connected to the second tank, the feet being configured to support the second tank on top of the first tank;
a cylindrical collar attached to an external surface of the second tank, the collar being positioned to slide over an upper portion of the rod when the second tank rests on the first tank; and
a threaded set screw inserted through a threaded hole in the collar, whereby tightening the set screw frictionally engages the screw with the rod and locks the second air tank immovable in relation to the compressor, and loosening the set screw disengages the screw from the rod and unlocks the second air tank to render it removable from the compressor.

11. The air compressor of claim 10, wherein the cylindrical collar is circular in cross section.

12. The air compressor of claim 10, further including a handle connected to the compressor for lifting the compressor, the handle being positioned substantially above the center of gravity of the compressor.

13. The air compressor of claim 10, wherein the handle is connected to the compressor through a post that is directly connected to the base platform.

14. The air compressor of claim 13, wherein the handle extends horizontally when the compressor is resting on a horizontal surface.

15. The compressor of claim 10, wherein the feet are spaced apart between nine and twenty inches.

16. The compressor of claim 10, wherein each foot terminates in a lowest point, and each lowest point lies in a single plane.

17. The compressor of claim 10, wherein a first end of the hose has a male quick-lock type connector for connection to a first female quick-lock type connector on the first tank, and a second end of the hose has a second female quick-lock type connector for connection to a male quick-lock type connector on the second tank, whereby the hose is disconnectable from both the first tank and the second tank, and further wherein the second tank has a third female quick-lock type connector adapted to connect with the male quick-lock type connector at the first end of the hose, the third quick-lock type connector being separated from the second tank by a regulator, for regulating the discharge of air from the second tank.
